(19) United States
(12) Patent Application Publication
(10) Pub. No.: US 2013/0208192 A1
(43) Pub. Date: Aug. 15, 2013

(54) REMOTE CONTROLLER AND METHOD FOR GENERATING CONTROL SIGNAL

(71) Applicants: Beijing Lenovo Software Ltd, (US); Lenovo (Beijing) Co., Ltd., (US)

(72) Inventor: Lei Zhang, Beijing (CN)

(73) Assignees: LENOVO (BEIJING) CO., LTD., Beijing (CN); BEIJING LENOVO SOFTWARE LTD, Beijing (CN)

(21) Appl. No.: 13/760,608

(22) Filed: Feb. 6, 2013

(30) Foreign Application Priority Data
Feb. 14, 2012 (CN) 201210032977.2

(51) Int. Cl. H04N 5/44

(52) U.S. Cl. CPC H04N 5/4403
USPC 348/734

(57) ABSTRACT

A remote controller and a method for generating a control signal are provided by the present invention. The remote controller is capable of being connected with an electronic device having a television function. The electronic device is playing a first program signal. The first program signal comes from a network connected with the electronic device. The remote controller includes: a data receiving unit adapted to receive the first program signal from the electronic device; a touch screen connected with the data receiving unit and adapted to display at least one display object corresponding to a second program signal when the data receiving unit receives the second program signal; a control unit connected with the touch screen; and a data transmitting unit adapted to transmit data of the remote controller to the electronic device.

The present application claims the priority of Chinese Patent Application No. 201210032977.2, titled “REMOTE CONTROLLER AND METHOD FOR GENERATING CONTROL SIGNAL”, and filed with the Chinese State Intellectual Property Office on Feb. 14, 2012, the entire disclosure of which is incorporated herein by reference.

### FIELD OF THE INVENTION

The present invention relates to the field of electronic technology, and in particular to a remote controller and a method for generating a control signal.

### BACKGROUND OF THE INVENTION

With unceasing development of communication technology, more and more electronic and electrical appliances such as a television set, a Blueray, a DVD and a home theater system have come into daily life and become indispensable in daily life, and watching television also has become a lifestyle. In the prior art, electronic devices are controlled by remote controllers, and most of the electronic devices are provided with dedicated remote controllers for controlling functions such as channel switching and picture setting of the electronic devices. The remote controller in the prior art has been developed into a touch screen remote controller which is designed with a touch screen, where no key-press entity is set. A picture being played on the electronic device is displayed synchronously on the remote controller, and the remote controller functions as a small electronic device. Functions such as channel switching and picture setting of the electronic device can be achieved by operating the remote controller.

However, in conceiving the invention, the inventor finds that the above-mentioned touch screen remote controller in the prior art is not perfect and has at least following technical problems.

When the touch screen remote controller is operated, the electronic device displays a same operation picture as that displayed on the touch screen remote controller, and the originally-played picture of the electronic device is overlaid. It is impossible that the electronic device displays the picture and at the same time the touch screen remote controller displays other operation objects or browses other pictures. Therefore, for the existing touch screen remote controller, dual operations including playing and browsing can not be performed simultaneously.

Furthermore, when the electronic device is used to play a movie or is connected to a DVD player to play a DVD, although the touch screen remote controller can display a progress of the movie being played on the electronic device, but the play progress bar can not be controlled to operate and preview the content segment of the movie not yet played and switch to this segment for playing.

### SUMMARY OF THE INVENTION

In view of the above, a remote controller and a method for generating a control signal are provided in the present invention, to solve the technical problem that the dual operations including playing and browsing can not be performed simultaneously on a remote controller in the prior art.

In one aspect of the present invention, a remote controller is provided, and the remote controller is capable of being connected with an electronic device having a television function. The electronic device is playing a first program signal. The first program signal comes from a network connected with the electronic device. The remote controller includes:

a data receiving unit adapted to receive the first program signal from the electronic device;

a touch screen connected with the data receiving unit and adapted to display at least one display object corresponding to a second program signal when the data receiving unit receives the second program signal;

a control unit connected with the touch screen; and

a data transmitting unit adapted to transmit data of the remote controller to the electronic device,

where when detecting that an operation is performed on a first display object of the display objects, the touch screen generates a first touch signal in response to the operation; the control unit converts the first touch signal to a first control signal and transmits the first control signal to the electronic device by the data transmitting unit; the electronic device plays the second program signal after executing the first control signal, where the first program signal and the second program signal are different program signals.

Optionally, the network connected with the electronic device is a cable television network or an internet.

Optionally, the touch screen includes a first display region and a second display region, where the display object is displayed in the second display region.

Optionally, the touch screen is further adapted to receive the first program signal by the data receiving unit and display the first program signal in the first display region.

Optionally, the touch screen is further adapted to receive at least one operation object corresponding to the first program signal by the data receiving unit and display the operation object in the second display region or in the first display region.

Optionally, the control unit is further adapted to convert a second touch signal to a second control signal when the touch screen detects the second touch signal, where the second touch signal is generated in response to an operation when the operation is performed on the operation object.

Optionally, the touch screen is further adapted to receive the second program signal by the data receiving unit and display the second program signal in the first display region.

Optionally, the remote controller further includes an image or video capture unit adapted to capture an image or a video, the image or the video is displayed by the touch screen.

In another aspect of the present invention, a method for generating a control signal is provided. The method is applied in a remote controller which is capable of being connected with an electronic device having a television function. The method includes:

receiving and displaying at least one display object corresponding to a second program signal;

generating a first touch signal in response to a first operation when it is detected that the first operation is performed on a first display object of the display objects; and

converting the first touch signal to a first control signal, to make the electronic device play the second program signal after executing the first control signal, where a first program signal and the second program signal are different program signals.

Optionally, the method further includes receiving and displaying at least one operation object corresponding to the first program signal.

Optionally, the method further includes converting a second touch signal to a second control signal when the second touch signal is detected, where the second touch signal is generated in response to an operation when the operation is performed on the operation object.

The following technical effects or advantages exist in one or more of the above-mentioned technical solutions.

The remote controller in the application receives a signal by the data receiving unit, and controls the electronic device to switch signals by using the control unit. While the electronic device is displaying a picture, other picture can be browsed and other operation object can be operated on the remote controller, and thereby the dual operations including playing and browsing can be performed at the same time.

Furthermore, while the electronic device is displaying a picture, the remote controller in the application may display synchronously the same picture as that displayed by the electronic device, and the play progress bar can be controlled to operate and preview a content segment of the movie not yet played and switch to this segment for playing.

### BRIEF DESCRIPTION OF THE DRAWINGS

FIG. 1 is a schematic diagram of a remote controller according to a first embodiment of the present invention;

FIG. 2 is a schematic diagram of a browse mode of the remote controller of the first embodiment of the present invention; and

FIG. 3 is a flowchart of a method for generating a control signal according to a second embodiment of the present invention.

### DETAILED DESCRIPTION OF THE INVENTION

In order to solve the technical problem that the dual operations including playing and browsing can not be performed simultaneously on a remote controller in the prior art, a remote controller and a method for generating a control signal are provided in embodiments of the present invention.

The remote controller in the application is a touch screen remote controller. When an electronic device displays a program signal, the remote controller may display synchronously the same program signal as that displayed by the electronic device. Moreover, the program signal is being watched and at the same time other objects on the remote controller may be operated, another different program signal may be obtained and chosen, and a switch may be performed to play the chosen program signal.

Additionally, the remote controller may also operate the program signal displayed by the electronic device, and the play progress bar may be controlled to operate and preview a content segment of the movie not yet played and switch to this segment for playing.

Main implementation principles, specific implementation processes and corresponding beneficial effects of embodiments of the present invention are described in detail below in conjunction with the accompanying drawings of the description.

### The First Embodiment

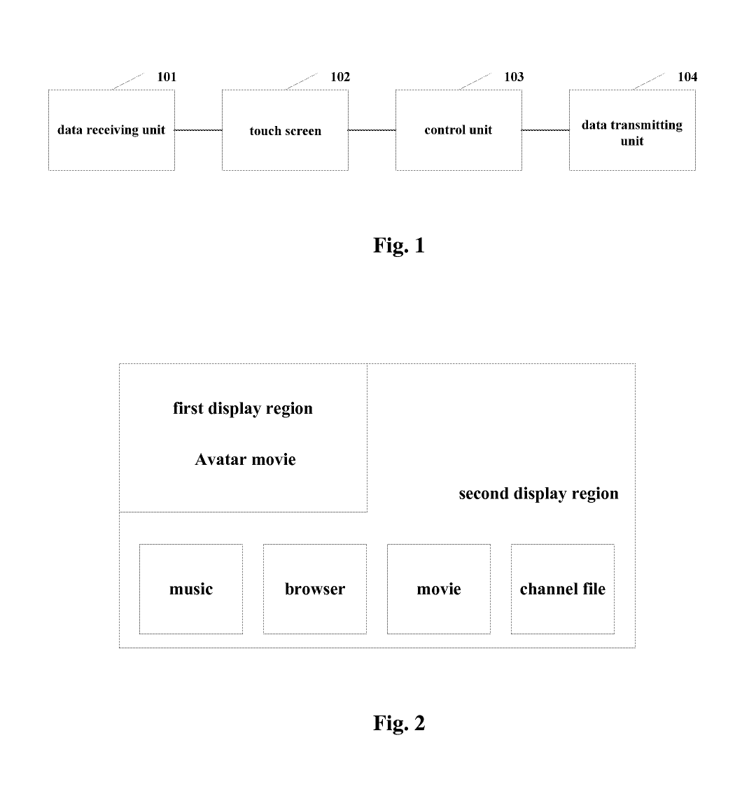

Reference is made to FIG. 1 which shows a remote controller provided by the application. The remote controller is capable of being connected with an electronic device having a television function. The electronic device is playing a first program signal. The first program signal comes from a network connected with the electronic device, and the network may be a cable television network or an internet.

The remote controller includes:

a data receiving unit 101 adapted to receive the first program signal from the electronic device;

a touch screen 102 connected with the data receiving unit 101 and adapted to display at least one display object corresponding to a second program signal when the data receiving unit 101 receives the second program signal;

a control unit 103 connected with the touch screen 102; and

a data transmitting unit 104 adapted to transmit data of the remote controller to the electronic device.

There are three working modes of the remote controller provided by the application, namely a synchronization mode, a browse mode and an interactive mode.

In the synchronization mode, the remote controller may display synchronously the program signal being played on the electronic device.

In the browse mode, while the first program signal being played on the electronic device is displayed synchronously, other display object may also be displayed. In this case, the touch screen 102 includes a first display region and a second display region, where the display object is displayed in the second display region, and the display object is at least one display object corresponding to the second program signal.

Additionally, the touch screen 102 displays the first program signal in the first display region. Specifically, the touch screen 102 receives the first program signal by the data receiving unit 101 and displays the first program signal in the first display region.

Further, when detecting that an operation is performed on a first display object of the display objects, the touch screen 102 generates a first touch signal in response to the operation. The control unit 103 converts the first touch signal to a first control signal and transmits the first control signal to the electronic device by the data transmitting unit 104. The electronic device plays the second program signal after executing the first control signal.

The first program signal and the second program signal are different program signals.

The first program signal may be obtained by the electronic device from the cable television network or the internet.

The second program signal may be obtained by the electronic device from the cable television network or the internet, or may be obtained by the remote controller itself from the cable television network or the internet.

Thus, there are three ways by which the remote controller controls the electronic device to make it switch from playing the first program signal to playing the second program signal, and the three switching ways are different.

The three ways are illustrated in the following examples.

Further, the touch screen 102 receives the second program signal by the data receiving unit 101 and displays the second program signal in the first display region.

The above description illustrates the process in which when the electronic device is playing the first program signal, the second program signal is generated and is controlled to be played on the electronic device by operating the remote controller.

Additionally, the touch screen 102 may also perform an operation on the first program signal. When the first program signal is displayed in the first display region, the touch screen 102 is further adapted to receive at least one operation object corresponding to the first program signal by the data receiving unit 101 and display the operation object in the second display region or in the first display region.

Further, when the touch screen 102 detects a second touch signal, the control unit 103 converts the second touch signal to a second control signal. The second touch signal is generated in response to an operation when the operation is performed on the operation object.

An illustration is given by way of examples as follows.

When the electronic device is playing Avatar movie, the remote controller displays the play progress of the Avatar being played on the electronic device.

Here, the played Avatar movie may be obtained by the electronic device from the cable television network, for example, the movie may be broadcasted by a movie channel. The movie may also be obtained by searching the internet by the electronic device.

At this time, the mode of the remote controller is the synchronization mode. The remote controller switches from the synchronization mode to the browse mode upon reception of an instruction. In the browse mode, besides synchronously displaying the play progress of the Avatar being played on electronic device, the touch screen 102 may also display other display objects, such as music, browser, movie and channel file. These display objects represent the display objects corresponding to the second program signal, and may be obtained from the cable television or the internet.

Further, the touch screen 102 includes the first display region and the second display region. The display objects such as the music, the browser, the movie and the channel file are displayed in the second display region, and the Avatar movie being played is displayed in the first display region of the touch screen 102 by the data receiving unit 101. A specific graphical representation is shown in FIG. 2.

FIG. 2 illustrates the schematic diagram of the remote controller, where the touch screen 102 of the remote controller includes the first display region and the second display region. The first display region displays the Avatar movie being played and the second display region displays other display objects, such as the music, the browser, the movie and the channel file.

If the remote controller controls the electronic device to make it switch from playing Avatar to playing other object such as If You Are the One, the Avatar and the If You Are the One are different program signals and there are three ways for switching as follows.

The First Way

The Avatar being played by the electronic device comes from the cable television network such as the movie channel, and the If You Are the One to be played comes from the internet.

In this case, when detecting that an operation is performed on the If You Are the One movie, the touch screen 102 generates a first touch signal in response to the operation.

Further, the control unit 103 converts the first touch signal to a first control signal and transmits the first control signal to the electronic device by the data transmitting unit 104.

In this case, the first control signal includes a first instruction and a second instruction. The first instruction is a signal source switching instruction, which controls the electronic device to make it switch its signal source from the cable television network to the internet.

The second instruction is a play switching instruction, which controls the electronic device to make it switch from playing the Avatar movie to playing the If You Are the One movie.

Further, after executing the first control signal, the electronic device switches its signal source from the cable television network to the internet, stops playing the Avatar movie and plays the If You Are the One movie.

At this time, the touch screen 102 receives the If You Are the One movie by the data receiving unit 101 and displays it in the first display region.

Additionally, when detecting that an operation is performed on the If You Are the One movie, the touch screen 102 generates a first touch signal in response to the operation, and the control unit 103 converts the first touch signal to the first control signal. Then, the control unit 103 may not transmit the first control signal to the electronic device, but receive other touch signals generated by the touch screen 102, for example, a touch signal generated by operating other movies such as Flash Point movie. Therefore, while the electronic device plays the original Avatar movie, the remote controller may receive other movie or receive an operation for browsing a webpage and the like.

The above process is also applied to both of the following second way and third way, and the description thereof is omitted in the following examples.

Herein the description is given by way of examples to illustrate the switching way in the case that the first program signal and the second program signal come from different signal sources, where a process of generating the second program signal and performing a control to play the second program signal on the electronic device by operating the remote controller when the electronic device is playing the first program signal is illustrated.

In the second way, the first program signal and the second program signal come from a same signal source, such as both come from the cable television network or the internet.

The Second Way

The Avatar being played by the electronic device comes from the cable television network, such as the movie channel, and the If You Are the One to be played also comes from the cable television network, such as Beijing Satellite TV.

In this case, when detecting that an operation is performed on the If You Are the One movie, the touch screen 102 generates a first touch signal in response to the operation.

Further, the control unit 103 converts the first touch signal to a first control signal and transmits the first control signal to the electronic device by the data transmitting unit 104.

In this case, the first control signal is a control signal for controlling the electronic device to make it switch from playing the Avatar movie to playing the If You Are the One movie.

Further, after executing the first control signal, the electronic device stops playing the Avatar movie and plays the If You Are the One movie.

At this time, the touch screen 102 receives the If You Are the One movie by the data receiving unit 101 and displays it in the first display region.

Herein the description is given by way of examples to illustrate the switching way in the case that the first program signal and the second program signal come from the same signal source, where a process of generating the second program signal and performing a control to play the second program signal on the electronic device by operating the remote controller when the electronic device is playing the first program signal is illustrated.

The Third Way

The Avatar being played by the electronic device comes from the internet, and the If You Are the One to be played comes from the cable television network such as the movie channel.

In this case, when detecting that an operation is performed on the If You Are the One movie, the touch screen 102 generates a first touch signal in response to the operation.

Further, the control unit 103 converts the first touch signal to a first control signal and transmits the first control signal to the electronic device by the data transmitting unit 104.

In this case, the first control signal includes a first instruction and a second instruction. The first instruction is a signal source switching instruction, which controls the electronic device to make it switch its signal source from the internet to the cable television network.

The second instruction is a play switching instruction, which controls the electronic device to make it switch from playing the Avatar movie to playing the If You Are the One movie.

Further, after executing the first control signal, the electronic device switches its signal source from the internet to the cable television network, stops playing the Avatar movie and plays the If You Are the One movie.

At this time, the touch screen 102 receives the If You Are the One movie by the data receiving unit 101 and displays it in the first display region.

The above description of the three ways is given by way of examples to illustrate a process of generating the second program signal and performing a control to play the second program signal on the electronic device by operating the remote controller when the electronic device is playing the first program signal, which solves the disadvantages in the prior art that although the remote controller may display the picture which is synchronous with that of the electronic device, but an operation performed on the touch screen remote controller appears on the electronic device when the touch screen remote controller is operated, and it is impossible that the electronic device displays a picture and at the same time other pictures are browsed on the remote controller, therefore dual operations including playing and browsing can not be performed simultaneously.

Additionally, the touch screen 102 may also operate the first program signal.

For example, when the electronic device is playing the Avatar movie, the touch screen 102 receives at least one operation object corresponding to the Avatar by the data receiving unit 101, such as an operation object of fast backward, fast forward, pause or stop, and displays the operation object in the second display region or in the first display region.

Further, when a user performs an operation, for example fast forward, on the Avatar movie on the touch screen, the user may see the content of the Avatar movie corresponding to the time instant to which the movie is fast forwarded on the touch screen 102.

Further, when the touch screen 102 detects an operation of fast forward, the control unit 103 responds to the operation and converts it to a second control signal.

Further, the data transmitting unit 104 transmits the second control signal to the electronic device, and the electronic device displays the corresponding content of the Avatar movie.

Additionally, the electronic device may be connected with a DVD player. When the movie is played by the DVD player, the electronic device displays the played content of the Avatar.

The touch screen 102 receives at least one operation object corresponding to the Avatar by the data receiving unit 101, such as an operation object of fast backward, fast forward, pause or stop, and displays the operation object in the second display region or in the first display region.

Further, when the user performs an operation, for example fast forward, on the Avatar movie on the touch screen 102, the user may see the content of the Avatar movie corresponding to the time instant to which the movie is fast forwarded on the touch screen 102.

Further, when the touch screen 102 detects the operation of fast forward, the control unit 103 responds to the operation and converts it to a second control signal.

Further, the data transmitting unit 104 transmits the second control signal to the DVD player, to make the content of the Avatar movie of the DVD player fast forward to the corresponding time instant displayed on the touch screen 102, and transmit it to the electronic device. Then the electronic device displays the corresponding content of the Avatar movie.

By the above method, the touch screen 102 may display synchronously the progress of the movie being played on electronic device, and may preview the content of the Avatar movie and fast forward the content of the Avatar to any time instant. Thereby, the following technical problem in the prior art is solved: although the touch screen remote controller can display synchronously the play progress of the movie being played on electronic device, but the play progress bar can not be controlled to operate and preview the content segment of the movie not yet played and switch to this segment for playing.

In addition to the above-mentioned synchronization mode and browse mode, there is another mode, namely the interactive mode, for the remote controller. In the interactive mode, the remote controller is provided with an image or video capture unit adapted to capture an image or a video, and the image or the video is displayed by the touch screen 102.

For example, when a user performs a video chart with another user by the electronic device, the remote controller may capture images or videos. The image and the video here include both the image and the video of the user using the remote controller and the image and the video of the other party. The remote controller displays the images and the videos of both parties when capturing the images and the videos.

Further, the remote controller may also transmit the captured images and videos to the electronic device by the data transmitting unit 104 for displaying on the electronic device.

### The Second Embodiment

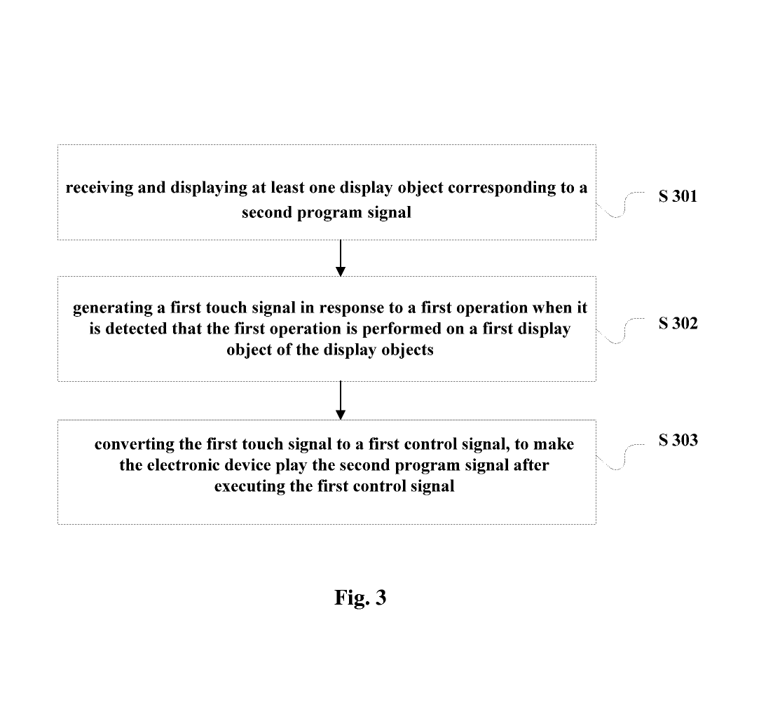

Further, reference is made to FIG. 3. A method for generating a control signal is provided in the second embodiment of the present invention, and the method is applied in a remote controller capable of being connected with an electronic device having a television function. The method includes:

S301, receiving and displaying at least one display object corresponding to a second program signal;

S302, generating a first touch signal in response to a first operation when it is detected that the first operation is performed on a first display object of the display objects; and

S303, converting the first touch signal to a first control signal, to make the electronic device play the second program signal after executing the first control signal, wherein a first program signal and the second program signal are different program signals.

Further, besides the above steps, the method further includes receiving and displaying at least one operation object corresponding to the first program signal.

Further, besides the above steps, the method further includes when a second touch signal is detected, converting the second touch signal to a second control signal, wherein the second touch signal is generated in response to an operation when the operation is performed on the operation object.

The following technical effects may be achieved by implementing one or more embodiments of the present invention.

The remote controller of the application receives a signal by the data receiving unit, and controls the electronic device to make it perform a signal switching by using the control unit. While the electronic device is displaying a picture, other picture can be browsed and an operation can be performed on other operation object on the remote controller, and thereby the dual operations including playing and browsing can be performed at the same time.

Furthermore, while the electronic device is displaying a picture, the remote controller of the application displays synchronously the same picture as that displayed by electronic device, and the play progress bar may be controlled to operate and preview the content segment of the movie not yet played and switch to this segment for playing.

It will be apparent to the skilled in the art that various changes and modifications may be made to the invention without departing from the spirit and the scope of the present invention. In this way, if these changes and modifications of the invention belong to the scope of the claims and the equivalent techniques thereof, the invention also intends to include these changes and modifications.

1. A remote controller, the remote controller is capable of being connected with an electronic device having a television function, the electronic device is playing a first program signal, and the first program signal comes from a network connected with the electronic device, wherein the remote controller comprises:
a data receiving unit adapted to receive the first program signal from the electronic device;
a touch screen connected with the data receiving unit and adapted to display at least one display object corresponding to a second program signal when the data receiving unit receives the second program signal;
a control unit connected with the touch screen; and
a data transmitting unit adapted to transmit data of the remote controller to the electronic device,
wherein when detecting that an operation is performed on a first display object of the display objects, the touch screen generates a first touch signal in response to the operation; the control unit converts the first touch signal to a first control signal and transmits the first control signal to the electronic device by the data transmitting unit; the electronic device plays the second program signal after executing the first control signal, wherein the first program signal and the second program signal are different program signals.

2. The remote controller according to claim 1, wherein the network connected with the electronic device is a cable television network or an internet.

3. The remote controller according to claim 1, wherein the touch screen comprises a first display region and a second display region, wherein the display object is displayed in the second display region.

4. The remote controller according to claim 3, wherein the touch screen is further adapted to receive the first program signal by the data receiving unit and display the first program signal in the first display region.

5. The remote controller according to claim 4, wherein the touch screen is further adapted to receive at least one operation object corresponding to the first program signal by the data receiving unit and display the operation object in the second display region or in the first display region.

6. The remote controller according to claim 5, wherein the control unit is further adapted to convert a second touch signal to a second control signal when the touch screen detects the second touch signal, wherein the second touch signal is generated in response to an operation when the operation is performed on the operation object.

7. The remote controller according to claim 3, wherein the touch screen is further adapted to receive the second program signal by the data receiving unit and display the second program signal in the first display region.

8. The remote controller according to claim 1, wherein the remote controller further comprises:
an image or video capture unit adapted to capture an image or a video, the image or the video is displayed by the touch screen.

9. The remote controller according to claim 2, wherein the remote controller further comprises:
an image or video capture unit adapted to capture an image or a video, the image or the video is displayed by the touch screen.

10. The remote controller according to claim 3, wherein the remote controller further comprises:
an image or video capture unit adapted to capture an image or a video, the image or the video is displayed by the touch screen.

11. The remote controller according to claim 4, wherein the remote controller further comprises:
an image or video capture unit adapted to capture an image or a video, the image or the video is displayed by the touch screen.

12. The remote controller according to claim 5, wherein the remote controller further comprises:
an image or video capture unit adapted to capture an image or a video, the image or the video is displayed by the touch screen.

13. The remote controller according to claim 6, wherein the remote controller further comprises:
an image or video capture unit adapted to capture an image or a video, the image or the video is displayed by the touch screen.

14. The remote controller according to claim 7, wherein the remote controller further comprises:
an image or video capture unit adapted to capture an image or a video, the image or the video is displayed by the touch screen.

15. A method for generating a control signal, the method is applied in a remote controller which is capable of being connected with an electronic device having a television function, the electronic device is playing a first program signal, wherein the method comprises:
receiving and displaying at least one display object corresponding to a second program signal;
generating a first touch signal in response to a first operation when it is detected that the first operation is performed on a first display object of the display objects; and
converting the first touch signal to a first control signal, to make the electronic device play the second program signal after executing the first control signal, wherein the first program signal and the second program signal are different program signals.

16. The method according to claim 15, wherein the method further comprises:
receiving and displaying at least one operation object corresponding to the first program signal.

17. The method according to claim 16, wherein the method further comprises:
converting a second touch signal to a second control signal when the second touch signal is detected, wherein the second touch signal is generated in response to an operation when the operation is performed on the operation object.
